(19) United States
(12) Patent Application Publication
(10) Pub. No.: US 2021/0300156 A1
(43) Pub. Date: Sep. 30, 2021

(54) EVAPORATOR NOISE REDUCTION

(71) Applicant: DENSO International America, Inc., Southfield, MI (US)

(72) Inventors: Zachary Stewart SCHMITT, Warren, MI (US); Lee ISENBERG, Grosse Pointe Park, MI (US); Prakash THAWANI, Bloomfield Hills, MI (US)

(21) Appl. No.: 16/835,428

(22) Filed: Mar. 31, 2020

(51) Int. Cl. B60H 1/32; B60H 1/00

(52) U.S. Cl. CPC B60H 1/3233; B60H 2001/006; B60H 1/00507; B60H 1/3202

(57) ABSTRACT

A sump for an evaporator is disclosed. The sump may comprise: a sump housing comprising an upper end and a lower end, wherein the upper end comprises an opening and the lower end comprises a floor having a drain; and a tray located within the opening, wherein the tray comprises a base and a plurality of partitions extending from the base towards the floor, wherein the plurality of partitions divide the sump housing into chambers in acoustic communication with one another via a gap at a distal end of each of the plurality of partitions, wherein each gap defines a spacing between the respective partition and the floor, wherein, when noise enters via the drain, the sump housing and tray reduce acoustic noise which exits the sump.

### TECHNICAL FIELD

The present disclosure relates to noise reduction at an air handling system.

### BACKGROUND

A heating, ventilation, and air conditioning (HVAC) system may be used to control an environment of an interior space of a motor vehicle. For example, the HVAC system may heat the interior space when outside temperatures are relatively low and may cool the interior space when outside temperatures are relatively high. The HVAC system or use thereof may increase acoustic noise within the vehicle's interior space.

### SUMMARY

According to one embodiment, a sump for an evaporator is disclosed. The sump may comprise: a sump housing comprising an upper end and a lower end, wherein the upper end comprises an opening and the lower end comprises a floor having a drain; and a tray located within the opening, wherein the tray comprises a base and a plurality of partitions extending from the base towards the floor, wherein the plurality of partitions divide the sump housing into chambers in acoustic communication with one another via a gap at a distal end of each of the plurality of partitions, wherein each gap defines a spacing between the respective partition and the floor, wherein, when noise enters via the drain, the sump housing and tray reduce acoustic noise which exits the sump.

According to another embodiment, a sump for an evaporator is disclosed. The sump may comprise: a sump housing comprising a first wall, a second wall, a third wall, a fourth wall, and a floor defining a cavity, wherein the floor comprises a drain; and a tray located within the cavity, wherein the tray comprises a base and a plurality of partitions extending from the base towards the floor, wherein the plurality of partitions comprise a first partition, a second partition, and a third partition, wherein the first partition is spaced from the first wall by a distance L1, wherein the second partition is spaced from the first partition by a distance L2, wherein the third partition is spaced from the second partition by a distance L3, wherein the third partition further is spaced from the third wall, wherein, when noise enters the sump via the drain, based on the distances L1, L2, and L3, the sump housing and tray reduce the noise that leaves the sump, wherein the distances L1, L2, and L3 correspond to maximum noise reduction of a plurality of resonant frequencies.

### BRIEF DESCRIPTION OF THE DRAWINGS

FIG. 1 is a schematic diagram illustrating an air handling system for a vehicle.

FIG. 2 is a top view of an embodiment of the air handling system.

FIG. 3 is an elevation view of the air handling system shown in FIG. 2.

FIG. 4A is a top and partial sectional view of an evaporator of the air handling system.

FIG. 4B is a top view of a tray of a sump of the evaporator.

FIG. 5 is an elevation view of the evaporator of FIG. 4 along section lines 5-5.

FIG. 6 is an enlarged view of a portion of FIG. 5 illustrating condensate drain paths within the sump of the evaporator.

FIG. 7 is the enlarged view of FIG. 6 illustrating road noise entering and being reflected within the sump.

FIG. 8 is the enlarged view of FIG. 6 illustrating blower noise entering and being reflected within the sump.

FIG. 9 is the enlarged view of FIG. 6 illustrating a plurality of spacings between a plurality of partitions of the sump.

FIG. 10 is a graphical depiction of noise reduction using the sump.

FIG. 11 is a side view of another embodiment of the tray of the sump.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

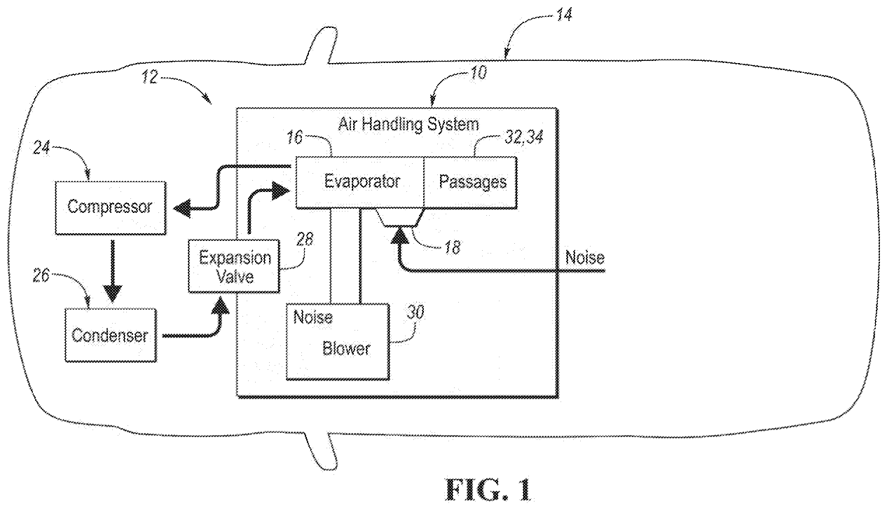

Turning now to the figures wherein like numerals indicate similar elements or features, an air handling system 10 of a heating ventilation and air conditioning (HVAC) system 12 is shown (FIGS. 1, 2, 3). Acoustic noise undesirably may enter a cabin (not shown) of a vehicle 14 via the air handling system 10. Among other things, acoustic noise may include road noise entering the cabin via an evaporator 16 of the air handling system 10; e.g., a sump 18 of the evaporator 16 may have a passage 20 for emptying condensate from the evaporator 16, but this passage 20—being open to an exterior environment of the vehicle 14—may consequently permit road noise to enter into the evaporator 16 and ultimately into the vehicle's cabin. E.g., road noise may refer to audible noise created by vehicle tires traversing a roadway, audible noise emanating from an engine of the vehicle 14, other audible noise from an exterior of the vehicle 14, and the like. As described in detail below, the sump 18 of the evaporator 16 may be configured as a silencer (or muffler) thereby reducing noise which may enter the cabin.

FIG. 1 illustrates that vehicle 14 may comprise the HVAC system 12; further, FIG. 1 illustrates an example of HVAC system 12 comprising a compressor 24, a condenser 26, and the air handling system 10. Vehicle 14 may be any suitable vehicle having a cabin—e.g., including a passenger vehicle, a pickup truck, a van, a heavy-equipment vehicle, an aircraft, a marine vessel, or the like. The term cabin may refer to an enclosure for carrying the passengers while the vehicle 14 traverses from one location to another. While not required in all examples, in at least one embodiment, it is desirable to reduce road noise within the cabin to improve the passenger experience. It will be appreciated that HVAC system 12 may be implemented in non-vehicle embodiments as well.

The HVAC system 12 circulates coolant within its system 12 in order to remove heat from the air delivered to the cabin of vehicle 14. Compressor 24 may comprise any suitable mechanical device that pressurizes coolant (typically in a gaseous state) to a high pressure and temperature. Accordingly, using the compressor 24, the coolant (in a gas state) may have high pressure and also a high temperature (in accordance with Gay-Lussac's Law). In vehicle embodiments, the compressor 24 may be belt-driven or the like.

Condenser 26 may comprise any suitable mechanical device that receives coolant from the compressor 24 and removes heat from the coolant. E.g., the condenser 26 may comprise, among other things, a coil and a heat exchanger (neither are shown). Thus, condenser 26 may liquify the coolant; thus, the coolant may leave the condenser 26 (in a liquid state) having a high pressure and high temperature. HVAC system 12 also may comprise an expansion valve 28—e.g., between the condenser 26 and air handling system 10 (more particularly, between the condenser 26 and the evaporator 16. The expansion valve 28 may change the pressure of the coolant from high to low; thus, the coolant (in a liquid state) received by air handling system 10 may be low temperature and low pressure).

Air handling system 10 may comprise a blower 30, the evaporator 16 (which receives the low pressure, low temperature liquid coolant from the condenser 26), and one or more passages 32, 34 facilitating fluid communication between the blower 30, the evaporator 16, and the vehicle cabin. Each will be discussed in turn.

Blower 30 may comprise any suitable mechanical device that moves air through the air handling system 10. E.g., blower 30 may comprise a multi-stage electric motor, a fan, etc. For example, blower 30 may be in fluid communication with evaporator 16 via passage 32, and evaporator 16 may be in fluid communication with passage 34 which may exit into the cabin of vehicle 14.

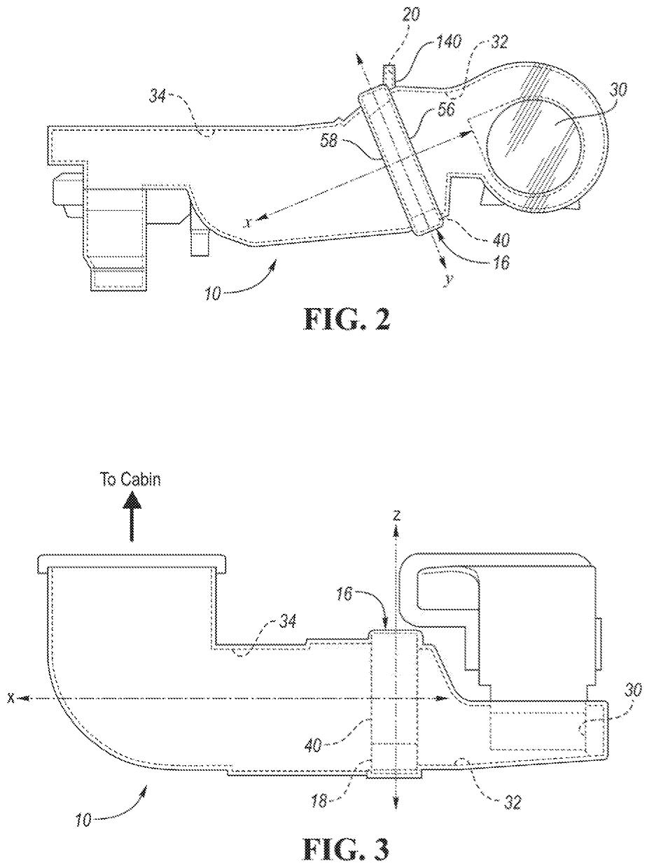

As shown in FIGS. 2, 3, 4A, 4B, 5, evaporator 16 may comprise an evaporator housing 40, coils 42 carried by the evaporator housing 40 (which coils 42 carry the low pressure, low temperature liquid coolant received from condenser 26), and the sump 18. In at least one embodiment, the expansion valve 28 is part of an assembly of the evaporator 16. According to at least one example, evaporator housing 40 may have an upper wall 48, a side wall 50, and a side wall 52, wherein side walls 50, 52 are spaced laterally from one another (with respect to a y-axis), wherein side walls 50, 52 extend downwardly from upper wall 48 (in a vertical direction, z-axis)—e.g., having a U-shape and defining an interior space 54. A first side 56 of upper and side walls 48-52 may face and/or be coupled to passage 32, and a second side 58 of upper and side walls 48-52 may face and/or be coupled to passage 34—in this manner, the forced air of blower 30 may move through the passage 32 (in a longitudinal direction along x-axis), then through evaporator housing 40, and then continue through passage 34 (to the vehicle cabin). Each side wall 50, 52 may comprise a distal end 60, 62, respectively, which is coupled to the sump 18.

Coils 42 may be located within the interior space 54. The arrangement of coils 42 is merely an example, and other examples are contemplated as well. When the blower 30 moves air across the coils 42, the air is cooled, and the cooled air may move through passage 34 and into the cabin of vehicle 14. When warmer air (in the evaporator housing 40) meets the relatively cold coils 42, humidity within the air may condense on an outer surface of the coils 42—forming droplets which grow large enough to fall under the force of gravity from the coils 42 into the sump 18.

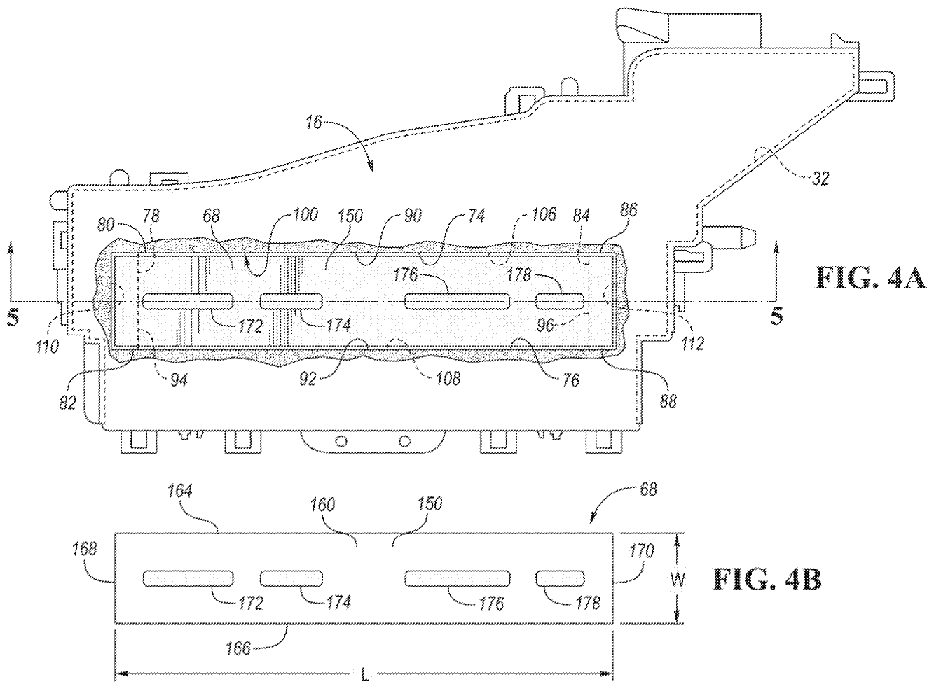

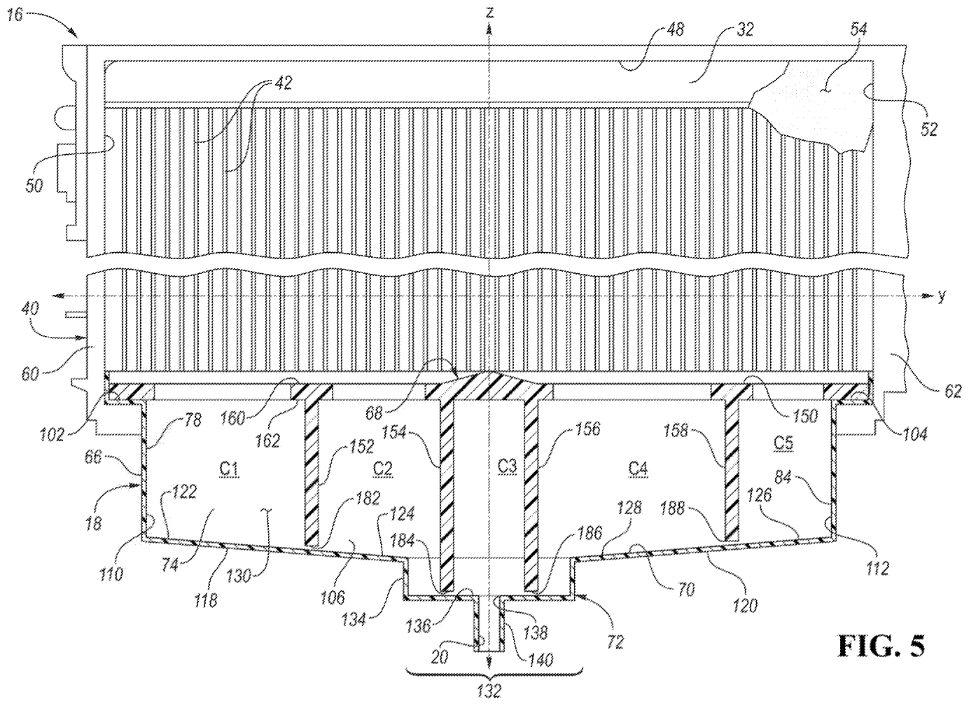

Sump 18 may be positioned relative to the coils 42 so that condensate formed on the coils 42 may fall under the force of gravity into the sump 18. As shown in FIGS. 4-5, sump 18 may comprise a sump housing 66 that is coupled to the distal ends 60, 62 of side walls 50, 52 and a tray 68 inserted within the sump housing 66. Sump 18 may be configured to move condensate received from the coils 42 to an exterior of the vehicle 14 and also muffle road noise, as well as some noise from blower 30 (a.k.a., blower noise; note: blower noise also be a type of acoustic noise).

Sump housing 66 may comprise a plurality of walls, a floor 70, and a drain 72 within the floor 78. The plurality of walls 70-76 may comprise a first wall 74, a second wall 76, a third wall 78 coupled to the first and second walls 74, 76 near first lateral ends thereof 80, 82 (respectively), and a fourth wall 84 coupled to the first and second wall 74, 76 near second lateral ends thereof 86, 88 (respectively)). Upper ends 90, 92, 94, 96 of the walls 74, 76, 78, 84 (respectively) (e.g., an upper end of the sump housing 66) may define an opening 100 (sized to receive the tray 68), wherein at least the third and fourth walls 78, 84 are coupled to side walls 50, 52 respectively of evaporator housing 40. According to an example, first and second walls 74, 76 may be longer (e.g., extend farther downwardly relative to the z-axis) than third and fourth walls 78, 84 such that the sump housing 66 has an elongated rectangular shape sized to receive the tray 68 (e.g., elongated laterally—e.g., with respect to the y-axis). According to one example, sump housing 66 may be approximately 50 millimeters (mm) in the x-axis direction (or e.g., within a range of 25-80 mm), approximately 265 mm in the y-axis direction (or e.g., within a range of 100-350 mm), and less than or equal to 50 mm in the z-axis direction (or e.g., 15-100 mm). More particularly with the z-axis direction, in one example, first and second walls 74, 76 each may be approximately 50 mm while third and fourth walls 78, 84 each may be approximately 15 mm. Other dimensions or combinations of dimensions could be used instead.

According to at least one example, the third and fourth walls 78, 84 each may comprise a lip (lip 102 and lip 104, respectively) which extends inwardly from side walls 50, 52, respectively; thus, when the tray 68 is located within the opening 100 of the walls 74, 76, 78, 84, the lips 102, 104 may support the tray 68. The lips 102, 104 are optional; e.g., the tray 68 could be retained within the sump housing 66 in other ways as well.

A lower end of the sump housing 66 may comprise floor 70. Floor 70 may be coupled to each of the walls 74, 76, 78, 84 at respective lower ends 106, 108, 110, 112 thereof (see FIG. 5 and also lower ends are shown with phantom lead lines in FIG. 4A). According to at least one example, the third and fourth walls 78, 84 are shorter than the first and second walls 74, 76. In this manner, the floor 70 may be at least partially inclined. In the illustrations, the floor 70 comprises a first portion 118 (nearer third wall 78) and a second portion 120 (nearer fourth wall 84). Still further, according to the illustrations, one end 122 of first portion 118 is coupled to lower end 110 (of third wall 78) and an opposite end 124 of first portion 118 is coupled to drain 72, and one end 126 of second portion 120 is coupled to lower end 112 (of fourth wall 84) and an opposite end 128 of second portion 120 is coupled to drain 72. First portion 118 may have any suitable slope; and similarly, second portion 120 may have any suitable slope which may be the same as or different from the slop of first portion 118.

Thus, as shown in the illustrated examples, the walls 74, 76, 78, 84 and floor 70 of the sump housing 66 may define a cavity 130 for receiving condensate and moving the condensate toward the drain 72. In the previous examples and in the figures, first and second walls 74, 76 are shown parallel to one another, third and fourth walls 78, 84 are shown parallel to one another, a length of the first portion 118 approximates the length of the second portion 120, etc. These are merely examples. Other shapes and orientations may be used instead—including different angular arrangements and/or curvatures.

In the illustrated example, drain 72 is positioned in a central area 132 of the floor 70; however, this is not required. Drain 72 may comprise a circular recess 134 comprising a base 136, an opening 138 at the base 136, and a drainpipe 140 coupled to the base 136 at the opening 138, wherein the passage 20 within the drainpipe 140 is in fluid communication (e.g., acoustic communication) with the cavity 130 of the sump housing 66 via opening 138 (passage 20 shown also in FIGS. 2-3). Recess 134 and/or the shape of the recess 134 is optional; e.g., the opening 138 could be within the floor 70 instead (e.g., no recess 134). Also, drainpipe 140 may be inclined as well to minimize condensate being retained within the drainpipe 140, recess 134, and/or cavity 130 of sump housing 66—e.g., since retention of condensate in these regions may result in undesirable odors propagating through the air handling system 10 and into the vehicle cabin (e.g., as bacteria, mold, etc. may grow in moist areas).

Turning now to tray 68 (an example of which is shown in FIGS. 4A, 4B, 5, 6, 7, 8, 9), the tray 68 may comprise a base 150 and a plurality of partitions 152, 154, 156, 158 which extend downwardly toward the floor 70 of the sump housing 66 (e.g., extend relative to the z-axis). Base 150 may comprise an upper side 160 and a lower side 162 and a plurality of edges 164, 166, 168, 170 defining a length (l) and width (w) thereof. According to an example, a shape of base 150 may be rectangular (e.g., extending longer in a lateral direction (in the y-axis direction) than in the x-axis direction); however, this is not required. According to at least one example, base 150 may be flat and may have a size and shape that coincides with the size and shape of the opening 100 of sump housing 66.

Tray 68 may have a plurality of through-holes 172, 174, 176, 180—e.g., the illustrated example comprises a first through-hole, a second through-hole (174), a third through-hole (176), and a fourth through-hole (178); however, other quantities of through-holes could be used instead. In the illustrated example, the through-holes 172, 174, 176, 180 are illustrated as laterally-extending slots (e.g., extending relative to the y-axis); however, this is merely an example (e.g., holes 172, 174, 176, 180 may be round, square, oval, etc. and may or may not be elongated or may be elongated differently).

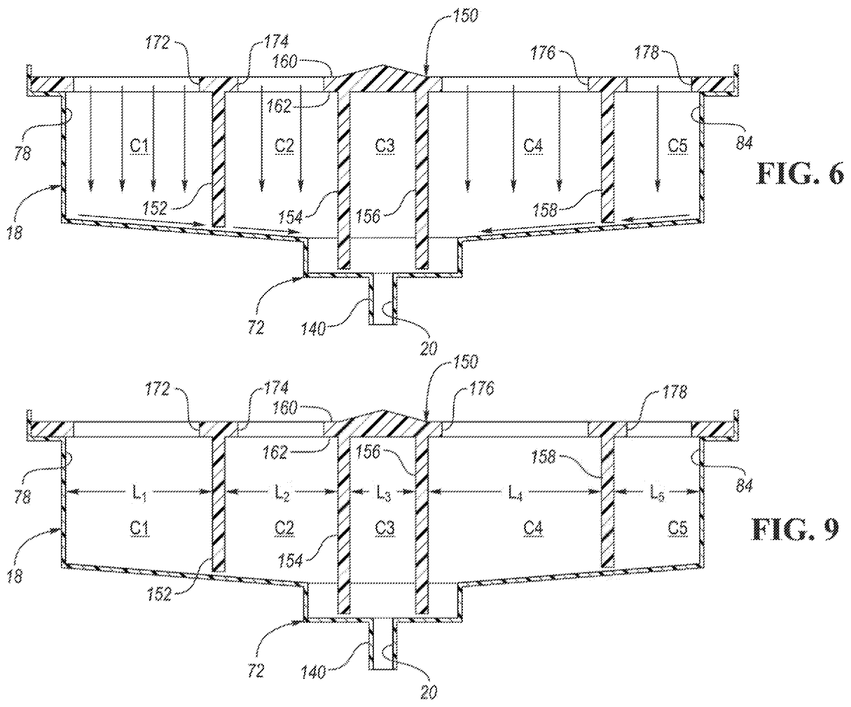

In the illustrated example, the plurality of partitions 152, 154, 156, 158 is shown as a first partition (152), a second partition (154), a third partition (156), and a fourth partition (158); however, other quantities of partitions could be used instead. Partitions 152, 154, 156, 158 may have a rectangular shape and be flat (e.g., extending in the longitudinal and vertical directions—e.g., with respect to the x- and z-axes). E.g., partitions 152, 154, 156, 158 may be parallel to one another and/or each may have a similar width as the base 150 of tray 68 (e.g., in the x-axis direction). Respective distal ends 182, 184, 186, 188 of partitions 152, 154, 156, 158 each may be spaced from the floor 70 (and/or base 136 of drain 72) by a gap so the partitions 152, 154, 156, 158 do not interfere with condensate fluid moving toward and/or through the drain 72 (e.g., see FIG. 6). Balancing this engineering trade-off, it may be desirable to minimize the gaps (e.g., 5-10 millimeters). However, the aforementioned description is merely an example. Other shapes, sizes, and orientations of partitions 152, 154, 156, 158 are contemplated also.

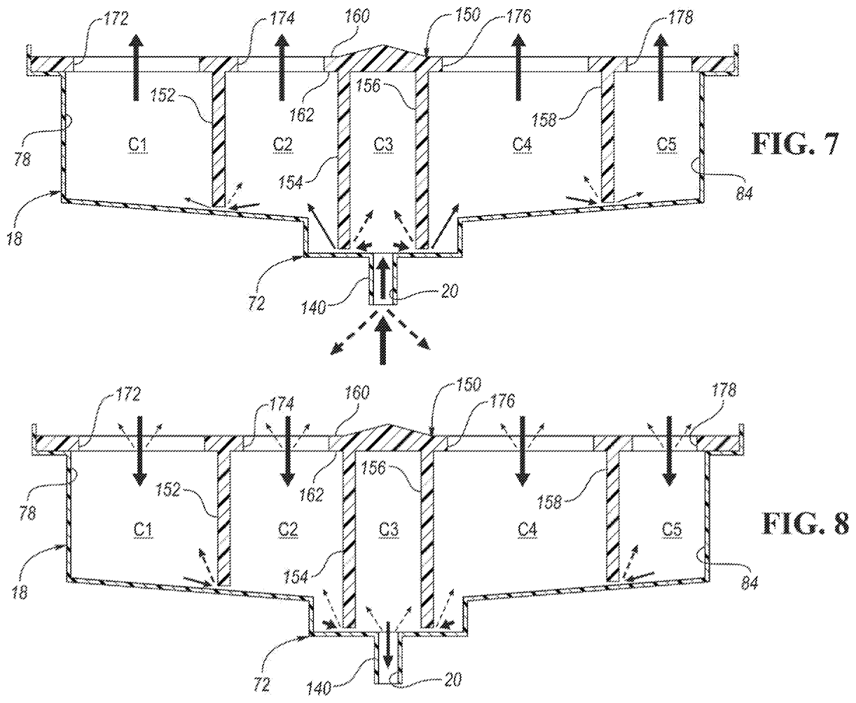

Thus, the partitions 152, 154, 156, 158 may divide the cavity 130 into a plurality of chambers C1, C2, C3, C4, C5 which are in acoustic communication with one another-which reduce (e.g. muffle) noise that otherwise may enter the cabin of the vehicle 14. Acoustic communication between chambers may refer to sound (e.g., including noise) being able to propagate between the chambers via openings, passages, gaps, etc. In the example illustration, through-holes 172, 174, 176, 178 are openings to chambers C1, C2, C4, C5, respectively; e.g., chamber C3 does not have a through-hole. This arrangement is merely an example, and other arrangements may be used instead. In FIGS. 7-8, noise (solid arrows) is shown, and reflected noise (phantom arrows) is also shown. For instance, FIG. 7 illustrates road noise (solid arrows) entering via passage 20 of drain 72, and FIG. 8 illustrates blower noise (solid arrows) entering via through-holes 172, 174, 176, 178. In the first example (FIG. 7), while some road noise is reflected (phantom arrows) backwardly (out the passage 20 again), the road noise (solid arrows) propagates undesirably through the passage 20, into the chambers C1-C5, and through the through-holes 172, 174, 176, 178—thereby making its way to the cabin of the vehicle 14 via passage 34. In the second example (FIG. 8), while some blower noise (solid arrows) escapes through the passage 20 of drain 72, other blower noise (solid arrows) passes through the through-holes 172, 174, 176, 178 and then is reflected (phantom arrows) from the chambers C1-C5 back through the through-holes 172, 174, 176, 178—thereby making its way to the cabin of the vehicle 14 via passage 34.

Road and blower noise entering the vehicle cabin may be reduced based on a spacing (e.g., distance) of the partitions 152, 154, 156, 158 from one another (and relative to the sump housing 66). As will be described more below, the sump housing 66 and tray 68 may be designed to be an offset type resonator (e.g., also called an offset type silencer), wherein the spacing of the partitions 152, 154, 156, 158 and of the third and fourth walls 78, 84 decreases the road and/or blower noise that escapes from the sump 18. As best shown in FIG. 9, first partition 152 may be spaced from the third wall 78 of sump housing 68 by a distance L1, second partition 154 may be spaced from the first partition 152 by a distance L2, third partition 154 may be spaced from the second partition 152 by a distance L3, fourth partition 158 may be spaced from the third partition 156 by a distance L4, and fourth partition 158 may be spaced from wall 84 of sump housing 66 by a distance L5. Each of the distances L1-L5 may differ, as explained below.

The resonance frequencies (f) of an offset type resonator may be calculated using Equation (1), wherein a frequency for which maximum noise reduction is achieved can be expressed in terms of a quarter wavelength λ

$$( i . e . , f = \frac{c}{4 L} , from L = \frac{1}{4} * \frac{c}{f} , wherein λ = \frac{c}{f} ) .$$

$$f = \frac{N * c}{4 * L} , \qquad Equation ( 1 )$$

Wherein N is an odd, positive integer (e.g., {1, 3, 5, 7, . . . }), wherein c is the speed of sound propagation through air

$$( e . g . , ∼ 1132 \frac{ft}{s} ( feet \text{/} second ) .$$

The value of L may be tuned in accordance with the noise of the frequencies (e.g., of the road noise and/or the blower noise) in order to achieve maximum noise reduction at the frequencies defined by Equation (1) and the odd, positive integers. E.g., road noise (and/or blower noise) may be in the band of 0-5000 Hz or any other suitable predetermined band of frequencies.

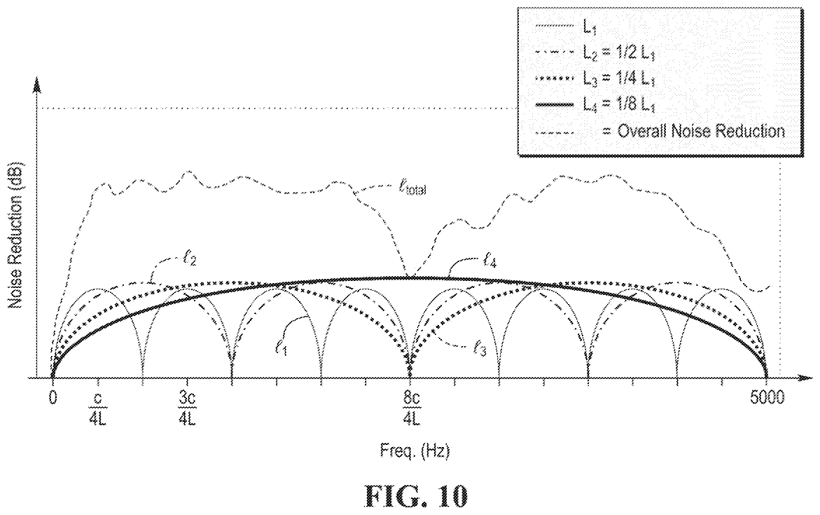

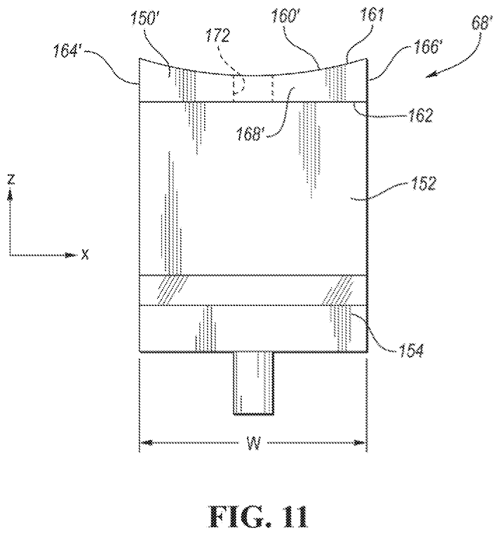

FIG. 10 illustrates a graphical depiction of overall noise reduction, wherein multiple values of L can be determined and used to achieve noise reduction. In this instance, a value of L1 is chosen, and L2=0.5*L1, L3=0.25*L1, and L4=0.125*L1. Thus, an independent axis of the graphical depiction illustrates frequency (in Hertz (Hz)) in increments of quarter wavelength, and a dependent axis illustrates total noise reduction (decibels (dB)). Accordingly, shown are an L1 noise reduction curve l₁, an L2 noise reduction curve l₂, an L3 noise reduction curve l₃, an L4 noise reduction curve l₄, and an overall noise reduction curve lₜₒₜₐₗ.

Using this technology applied to the instant application, the values of L1, L2, L3, L4, and L5 may be determined based on a range of frequencies desired to be silenced—in one non-limiting example, between 0 to 5000 Hz. E.g., this range may correspond to a predetermined band of frequencies associated with road noise, blower noise, or a combination thereof. Furthermore, the values of L1-L5 may be constrained by spatial constraints. For example, in an implementation wherein air handling system 10 is used within vehicle 14, spatial envelopes for the evaporator 16 (e.g., evaporator housing 40 and sump 18) may be constrained according to customer requirements (e.g., those of a vehicle original equipment manufacturer (OEM)). Continuing with the non-limiting examples set forth above of dimensions of the sump housing 66, broadband noise reduction could be achieved using the following values of L1-L5: L1=3.25″, L2=1.75″, L3=1.5″, L4=2.75″, and L5=2.25″. Of course, this is merely an example, and other example values of any one of L1 to L5 (and/or combinations thereof) also exist.

Other embodiments of evaporator 16 are also possible. For example, as shown in FIG. 11, a side elevation view of another embodiment of tray 68 is shown (i.e., tray 68′). Previously, base 150 was described as flat. Here, a base 150′ of tray 68′ has an upper side 160′ that comprises an inclined region 161 that promotes movement of moisture on the base 150′ toward the through-holes (e.g., through-hole 172 is shown in phantom)—e.g., so that moisture does not collect on the base 150′. In this example, the inclined region 161 is curved; in similar examples, the inclined region 161 may have one or more bezels or angular features to promote movement toward the through-holes 172-178. FIG. 11 illustrates other features are shown as well (e.g., including edges 164′, 166′, 168′).

According to another embodiment, one or more of the partitions 152, 154, 156, 158 (and/or walls 78, 84) are only substantially parallel to one another. Substantially parallel may refer to a predetermined tolerance (e.g., within +/−1 degrees of parallel).

The above described air handling system 10 may be manufactured according to any suitable technique. In at least one example, the sump housing 66 may be formed using any suitable polymer and may be formed in two halves (e.g., along vertical z-axis) via injected molding. Thereafter, the tray 68 may be positioned between the two halves, and the two halves may be coupled to one another. The evaporator housing 40 also may be manufactured using injection molded plastic. The coils 42 may be located within the evaporator housing 40, and the evaporator housing 40 with coils 42 may be coupled to the sump 18 (to form evaporator 16). And thereafter, the evaporator 16 may be assembled between the passage 32 and the passage 34. Blower 30 may be assembled and located in or coupled to passage 32 as well. In at least one example, the air handling system 10 may be delivered as a sellable unit. In other examples, the evaporator 16 only may be delivered as a sellable unit.

Thus, there has been described an air handling system comprising an evaporator and a blower. The evaporator is configured to guide moisture to an exterior of the system via a passage (e.g., outside a vehicle). Further, the evaporator is configured to reduce noise that otherwise may enter a cabin of the vehicle. More particularly, a sump of the evaporator may comprise a tray that includes a base and a plurality of partitions which extend from the base, wherein the partitions have a spacing from one another, as well as from walls of a sump housing, such that the sump functions as an offset type resonator. E.g., the sump muffles road noise that may enter from the passage (to the vehicle exterior) and/or noise that may be generated by the blower.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A sump for an evaporator, comprising:
a sump housing comprising an upper end and a lower end, wherein the upper end comprises an opening and the lower end comprises a floor having a drain; and
a tray located within the opening, wherein the tray comprises a base and a plurality of partitions extending from the base towards the floor, wherein the plurality of partitions divide the sump housing into chambers in acoustic communication with one another via a gap at a distal end of each of the plurality of partitions, wherein each gap defines a spacing between the respective partition and the floor, wherein, when noise enters via the drain, the sump housing and tray reduce acoustic noise which exits the sump.

2. An air handling system, comprising: an evaporator, and the sump of claim 1, wherein the evaporator comprises coils and an evaporator housing carrying the coils, wherein the evaporation housing is coupled to the upper end of the sump housing, wherein the coils are positioned within the evaporator housing so that condensate formed on the coils gravitationally moves toward the base of the tray.

3. The air handling system of claim 2, further comprising: a blower, and at least one passage, wherein the sump and the blower are in fluid communication via the at least one passage.

4. The sump of claim 1, wherein the floor is inclined relative to the evaporator housing to promote movement of the condensate toward the drain.

5. The sump of claim 1, wherein the base comprises a plurality of through-holes.

6. The sump of claim 5, wherein the base comprises at least one inclined region to promote movement of the condensate towards at least one of the plurality of through-holes.

7. The sump of claim 1, wherein each of the plurality of partitions are substantially parallel to one another.

8. The sump of claim 1, wherein the sump housing comprises a first wall, a second wall, a third wall, and a fourth wall, wherein the first, second, third, and fourth walls and the floor define an elongated cavity.

9. The sump of claim 8, wherein the plurality of partitions comprise a first partition, a second partition, and a third partition, wherein the first partition is spaced from the first wall by a distance L1, wherein the second partition is spaced from the first partition by a distance L2, wherein the third partition is spaced from the second partition by a distance L3, wherein the third partition further is spaced from the third wall, wherein each of the distances L1, L2, and L3 are different.

10. The sump of claim 9, wherein, when road noise is received via the drain, the plurality of partitions reduces the road noise based on the distances L1, L2, and L3 corresponding to maximum noise reduction of a plurality of resonant frequencies.

11. The sump of claim 10, wherein road noise is between 0-5000 Hertz.

12. The sump of claim 11, wherein the plurality of partitions and distances L1, L2, and L3 reduce blower noise received at the sump via a blower which is in fluid communication with the sump, wherein the blower noise is also between 0-5000 Hertz.

13. The sump of claim 9, wherein the plurality of partitions further comprises a fourth partition, wherein the fourth partition is spaced from the third partition by a distance L4, wherein the fourth partition is spaced from the third wall by a distance L5, wherein each of the distances L1, L2, L3, L4, and L5 are different.

14. The sump of claim 13, wherein, when road noise is received via the drain, the plurality of partitions reduces the road noise based on the distances L1, L2, L3, L4, and L5 corresponding to maximum noise reduction of a plurality of resonant frequencies.

15. A sump for an evaporator, comprising:
a sump housing comprising a first wall, a second wall, a third wall, a fourth wall, and a floor defining a cavity, wherein the floor comprises a drain; and
a tray located within the cavity, wherein the tray comprises a base and a plurality of partitions extending from the base towards the floor, wherein the plurality of partitions comprise a first partition, a second partition, and a third partition, wherein the first partition is spaced from the first wall by a distance L1, wherein the second partition is spaced from the first partition by a distance L2, wherein the third partition is spaced from the second partition by a distance L3, wherein the third partition further is spaced from the third wall, wherein, when noise enters the sump via the drain, based on the distances L1, L2, and L3, the sump housing and tray reduce the noise that leaves the sump, wherein the distances L1, L2, and L3 correspond to maximum noise reduction of a plurality of resonant frequencies.

16. The sump of claim 15, wherein the plurality of partitions further comprises a fourth partition, wherein the fourth partition is spaced from the third partition by a distance L4, wherein the fourth partition is spaced from the third wall by a distance L5, wherein each of the distances L1, L2, L3, L4, and L5 are different.

17. The sump of claim 16, wherein, when noise is received via the drain, the plurality of partitions reduces the noise based on the distances L1, L2, L3, L4, and L5 corresponding to maximum noise reduction of a plurality of resonant frequencies.

18. The sump of claim 16, wherein the distances L1, L2, L3, L4, and L5 are based on values of L for:
$$f = \frac{N * c}{4 * L} ,$$
wherein N is an odd, positive integer (e.g., {1, 3, 5, 7, . . . }), wherein c is the speed of sound propagation through air, wherein the distances L1, L2, L3, L4, and L5 are determined to reduce noise for a predetermined band of frequencies.

19. An air handling system, comprising: an evaporator, and the sump of claim 15, wherein the evaporator comprises coils and an evaporator housing carrying the coils, wherein the evaporation housing is coupled to the upper end of the sump housing, wherein the coils are positioned within the evaporator housing so that condensate formed on the coils gravitationally moves toward the base of the tray.

20. The air handling system of claim 19, further comprising: a blower, and at least one passage, wherein the sump and the blower are in fluid communication via the at least one passage.
